(19) United States
(12) Patent Application Publication
(10) Pub. No.: US 2020/0363976 A1
(43) Pub. Date: Nov. 19, 2020

(54) Multithreading for Rotation Operations in a File System

(71) Applicant: MICROSOFT TECHNOLOGY LICENSING, LLC, Redmond, WA (US)

(72) Inventors: Liyang LU, Kirkland, WA (US); Rajsekhar DAS, Sammamish, WA (US)

(21) Appl. No.: 16/411,128

(22) Filed: May 13, 2019

(51) Int. Cl. G06F 3/06; G06F 16/11; G06F 9/48; G06F 16/17; G06F 16/18

(52) U.S. Cl. CPC G06F 3/0647; G06F 3/0604; G06F 3/0644; G06F 16/1858; G06F 16/119; G06F 9/4881; G06F 16/1734; G06F 3/0673

(57) ABSTRACT

Methods, systems, and computer storage media are provided for facilitating data rotation operations using a multi-threaded implementation. In one embodiment, a volume analysis operation is executed to identify a first candidate data set for rotation from a first volume tier of a volume to a second volume tier of the volume associated with a file system. Thereafter, a rotation entry is added in a queue, the rotation entry generally indicates the first candidate data set for rotation from the first volume tier to the second volume tier. A first rotation worker thread can access the queue and rotate the first candidate data set from the first volume tier to the second volume tier, while a second volume analysis operation is executed to identify a second candidate data set to rotate. Further, a second rotation worker thread can access the queue and rotate the second candidate data set.

### BACKGROUND

Users rely on file systems for organizing data and files on computing systems. A file system, such as a resilient file system (ReFS), provides structure and logic rules to manage naming and grouping of data. File systems, such as resilient file systems, can support a tiered volume to deliver high performance and capacity-efficient storage. For example, ReFS can divide a volume into two logical storage groups, also referred to as volume tiers or tiers. One volume tier can be configured to deliver fast storage for hot data (more frequently accessed data), while another volume tier can be configured to deliver capacity-efficient storage for cold data (less frequently accessed data). Data can be moved, via a process known as rotation, from one volume tier to another volume tier such that data is stored in association with a logical storage tier that corresponds with the frequency of the accessed data. As more and more data is ingested via a file system, particularly in association with server applications, efficiently performing the rotation operation is important to maintain or enhance efficiency of the file system.

### SUMMARY

Various aspects of the technology described herein are generally directed to systems, methods, and computer storage media for, among other things, enhanced data rotation via multithreading for rotation operations. In this way, multiple threads can be used to perform different aspects of the rotation operation enabling parallel execution and thereby increasing efficiency of data rotation in a file system, such as a resilient file system.

In accordance with various embodiments described herein, a volume can be analyzed, via an analysis thread, to identify a data set(s) to rotate from one volume tier to another volume tier. For example, a data set can be rotated from one volume tier to another volume tier, while a band—a contiguous range of storage—is rotated (or allocated) from one volume tier to another volume tier. Upon identifying data sets to rotate between volume tiers, an indication thereof can be added in a queue for access by one or more rotation worker threads that perform the data rotation. Advantageously, using a thread to perform the volume analysis and a separate thread, or set of threads, to execute the data rotation enhances the performance and efficiency of the file system. For example, data sets to rotate can be identified concurrently, at least in part, with data rotation thereby increasing the efficiency of the overall data rotation operation. Further, multiple worker threads can be employed to perform the data rotation, thereby further increasing the efficiency of a file system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a block diagram of an exemplary environment for facilitating enhancement of data rotation via multithreading for rotation operations, suitable for use in implementing aspects of the technology described herein;

FIG. 2 is an example file system engine in accordance with aspects of the technology described herein;

FIG. 3 provides a first example method of facilitating enhancement of data rotation via multithreading for rotation operations, in accordance with aspects of the technology described herein;

FIG. 4 provides a second example method of facilitating enhancement of data rotation via multithreading for rotation operations, in accordance with aspects of the technology described herein;

FIG. 5 provides a third example method of facilitating enhancement of data rotation via multithreading for rotation operations, in accordance with aspects of the technology described herein;

FIG. 6 provides a block diagram of an exemplary file system environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview of Aspects of the Technological Improvement

A file system, such as a resilient file system (ReFS), provides structure and logic rules to manage storage and retrieval, and naming and grouping of data. The file system operates to maximize data availability, scale efficiently to large data sets across diverse workloads, and provide data integrity by means of resiliency to corruption. File systems typically support volumes or logical drives, which are accessible storage areas associated with a file system. Some file systems, such as ReFS, can support tiered volumes. A tiered volume or multi-tiered refers to a volume having multiple tiers, also referred to as multiple logical storage groups. For example, ReFS can support and/or generate a volume having two logical tiers. The volume tiers may support various types of storage devices, such as hard disk drives (HDDs) and solid-state drives (SSDs).

Using a multi-tiered volume can enable optimization of storage, for instance, based on disk and resiliency types. As one example, ReFS may divide a volume into a performance tier and a capacity tier. In this way, ReFS supports a tiered volume to deliver high performance and capacity-efficient storage. In operation, hot data can generally be written or stored on the performance tier, while cold data can generally be written or stored on the capacity tier. Accordingly, data more frequently accessed (hot data) is written on the performance tier to deliver fast storage, while data less frequently accessed (cold data) is written on a capacity tier to deliver capacity-efficient storage. Utilizing capacity-efficient storage for less-frequently accessed data can be cost effective given that capacity-efficient storage (e.g., HDD) is generally slower, and therefore, less expensive media.

As described, more frequently accessed data (also referred to herein as hot data) is generally written on a performance tier of a volume, and less frequently accessed data (also referred to herein as cold data) is generally written on a capacity tier of the volume. As data can become more or less frequently accessed over time, a file system may utilize a rotation operation to rotate or move data from one tier to another tier. For example, as hot data becomes less-frequently accessed (e.g., as compared to previous accesses for the particular data or as compared to accesses for other data), the data may be rotated or moved from a performance tier to a capacity tier (or vice versa). As another example, data writes may occur initially in the performance tier and, as the data is recognized as less frequently accessed, the can be rotated to the capacity tier (e.g., in real time). The rotation operation can further include allocating a band from one volume tier to another volume tier, while a band—a contiguous range of storage—is rotated (or allocated) from one volume tier to another volume tier. A band may be composed of a number of clusters. Clusters are units of storage defined by the file system. For example, a cluster may include 4 kB of storage space. If a band contains 64 MB, and each cluster is 4 kB, then a band comprises 16384 clusters. The file system tracks which clusters of a given band are allocated by a cluster allocation bitmap. A cluster allocation bitmap contains one bit for each cluster of a band, where a value of ‘1’ indicates cluster is already been allocated for some other use, and a value of ‘0’ indicates a cluster is unallocated and available for use. The file system (e.g., an allocator) searches for free space within a band by searching for enough consecutive ‘0’s in the bitmap to satisfy the allocation request.

Executing a rotation operation is typically implemented using a single-threaded mechanism. In particular, conventional file systems implement a single-threaded mechanism based on a single worker thread to identify data to rotate and to perform rotation of data from one tier to another tier. In this way, a combined logic is used to identify data for rotation in a first step and to execute the rotation in a second step. Such steps are performed sequentially using a single worker thread. For instance, in conventional systems, a single worker thread is used to determine files (e.g., data blocks) in a performance tier to rotate to a capacity tier, or vice versa, and also to perform the rotation of the files from the performance tier to the capacity tier.

Using a single-threaded mechanism to perform rotation operations, including both volume analysis and rotation execution, however, can be inefficient. In many cases, a single worker thread that analyzes and locates files or data ranges (e.g., 64 MB blocks) to rotate from one tier to another as well as performs rotation execution cannot keep up with the amount of data to be moved between tiers. To this end, a single thread worker sequentially identifying data candidates for rotation and then executing rotation of data is oftentimes slow (e.g., reading and writing 64 MB of data) and, as such, unable to support high volume workloads. For instance, in cases in which numerous files are being written, particularly with server applications, the workload to move files from one volume tier to another volume tier is too much for a single thread. In such cases that a single thread is unable to keep up with the speed at which data is ingested, oftentimes, the performance tier becomes occupied with data resulting in additional hot data being allocated to the capacity tier. Allocating hot data to a capacity tier, however, can result in an efficient file system.

Accordingly, embodiments of the present invention relate to methods, systems, and computer storage media for providing multithreading for rotation operations in a file system, such as a resilient file system. In particular, rotation operations are executed using multiple threads to expedite operations in a tiered volume configuration. At a high level, and in operation, a volume analyzer may analyze, via an analysis thread, a volume to identify a data set(s) for which to perform data rotation. Such identified data set(s) for rotation can be stored in a queue accessible by one or more worker threads that can perform the rotation operation for any data sets in the queue. In this way, the volume analyzer can execute volume analysis concurrently, or in parallel, with the rotation of data. Advantageously, executing volume analysis in parallel with data rotation enables a more efficient rotation operation and, therefore, a more efficient file system. Further, multiple worker threads configured to perform data rotation can handle much larger workloads and thereby provide a more efficient implementation of a tiered volume of a file system, such as ReF S. In this regard, a multi-threaded mechanism enables sufficient handling of workloads with increased amounts of writes in a computing environment such that latency for performing rotation operations is reduced. As such, computing operations in a file system, such as a resilient file system, are improved.

### Overview of Example Environments for Facilitating Enhancement of Data Rotation Operations via a Multi-Threaded Implementation

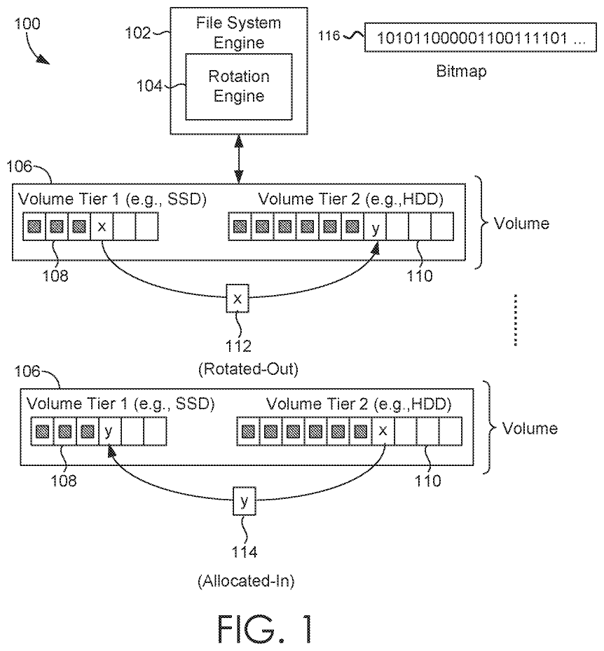

Referring initially to FIG. 1, a block diagram of an exemplary environment 100—a technical solution environment including a technical solution system—suitable for use in implementing embodiments of the invention is shown. Generally, the environment 100 illustrates an environment suitable for facilitating data rotation operations using a multi-threaded implementation.

FIG. 1 illustrates a rotation operation being performed by a file system engine 102. As shown, file system engine 102 supports a volume 106. Although illustrated as supporting a single volume, file system 102 may support any number of volumes and is not intended to be limited herein. The volume 106 includes a first volume tier 108 and a second volume tier 110. In embodiments, the first volume tier is a performance tier that generally provides fast data storage, and the second volume tier is a capacity tier that generally provides capacity-efficient storage. As such, data more frequently accessed (hot data) is generally written on the performance tier, volume tier 108, to provide fast storage, while data less frequently accessed (cold data) is written on the capacity tier, volume tier 110, to provide capacity-efficient storage.

The volume tiers 108 and 110 may support various types of storage devices. For example, volume tier 108, which may be a performance tier intended to provide fast data storage, may support SSD, while volume tier 110, which may be a capacity tier intended to provide capacity-efficient storage, may support HDD. As data is generally accessed at different rates, data accessed more frequently can be stored in SSD, which operates at a faster rate providing enhanced performance. In contrast, data accessed less frequently can be stored in HDD, which is less expensive storage operating at a slower rate. Such a tiered volume is particularly useful when extensive amounts of data are read/written, particularly in connection with server applications (e.g., having dynamic workloads). Although volume 106 is illustrated as having two logical tiers, embodiments are not intended to be limited herein.

As shown, both the volume tier 108 and 110 include data (e.g., sets or blocks of data). The rotation engine 104 of the file system engine 102 can analyze the volume 106. For example, the rotation engine 104 may analyze data within volume tier 108 and volume tier 110 to assess or identify data to rotate from one tier to another tier. In this example, assume the rotation engine 104 identifies data set 112 as a data set to rotate from volume tier 108 to volume tier 110. As described, the rotation engine 104 may identify to rotate data set 112 based on data set 112 being less frequently accessed (e.g., than previously access, accessed below a threshold level, etc.). In accordance with identifying to rotate data set 112, the rotation engine 104 can execute the rotation such that data set 112 is rotated to volume tier 110.

The rotation engine can further execute a second portion of the rotation operation—allocating a band (e.g., band 114—a contiguous range of storage) from one volume tier to another volume tier. The file system engine 102 tracks which clusters of a given band are allocated by a cluster allocation bitmap 116. A cluster allocation bitmap contains one bit for each cluster of a band, where a value of ‘1’ indicates cluster is already been allocated for some other use, and a value of ‘0’ indicates a cluster is unallocated and available for use. The rotation engine 104 can execute the rotation such that band 114 is rotated (allocated) to volume tier 108. In this way, data set 112 can reside in volume tier 110 and the band 114 can be allocated to volume tier 108 for more capacity-efficient, and less expensive, storage. Further, such rotation enhances efficiency of the volume 106 as volume tier 108 can be more available for more frequently accessed data.

By way of example only, assume file system engine 102 is a resilient file system. In such a case, data set 112 may be initially written to volume tier 108, a performance tier. Upon determining or identifying that data set 112 is accessed less frequently (e.g., less than a threshold rate, or not accessed within a threshold amount of time), the data set 112 can be automatically moved from the volume tier 108 to the volume tier 110. In embodiments, a resilient file system can utilize an indirection table(s) to move data. As such, multiple data sets (e.g., a range of 64 MB blocks) can be moved between tiers using a single read and write operation.

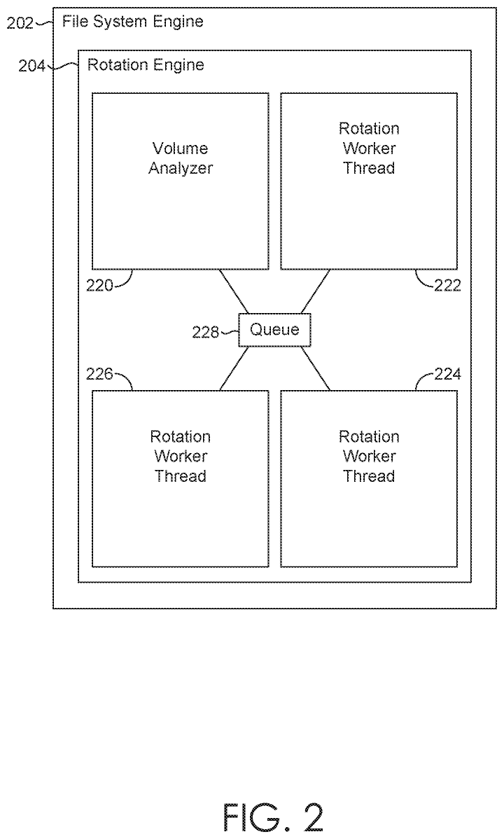

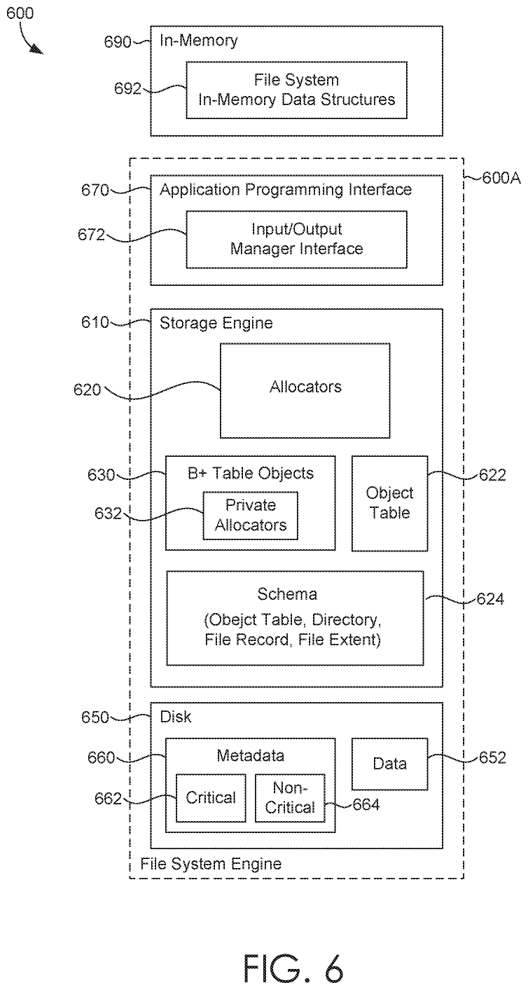

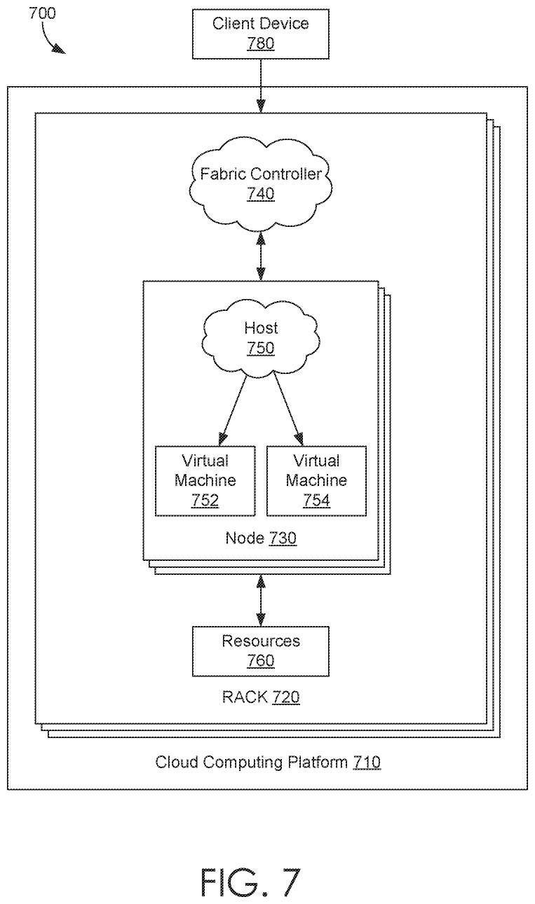

FIG. 2 illustrates an exemplary file system engine 202 that may facilitate enhanced data rotation via multithreading for rotation operations, in accordance with embodiments described herein. The environment 200 shown in FIG. 2 is an example of one suitable environment and is not intended to suggest any limitation as to the scope of use or functionality of embodiments disclosed throughout this document. Neither should the exemplary environment 200 be interpreted as having any dependency or requirement related to any single component or combination of components illustrated therein. The file system engine 202 may be included in a file system, such as the file system described in FIG. 6. Further, the file system engine 202 may operate in association with any computing device capable of operating a file system. For example, in an embodiment, the file system engine 202 can be included in computing device 700, as described above with reference to FIG. 7. In embodiments, the computing device 700 can be a personal computer (PC), a laptop computer, a workstation, a mobile computing device, a PDA, a cell phone, a server, or the like. A computing device can include one or more processors and one or more computer-readable media. The computer-readable media may include computer-readable instructions executable by the one or more processors.

The file system engine 202 generally manages storage of data on media. In this way, file system engine 202 can facilitate reads and writes of data in association with a volume(s), such as volume 106 of FIG. 1. As illustrated in FIG. 2, the file system engine 202 includes a rotation engine 204, in accordance with embodiments described herein.

The rotation engine 204 is generally configured to perform rotation operations including volume analysis and rotation. In doing so, and as described more fully below, a multi-threading implementation is utilized to perform such rotation operations. Advantageously, using a multithreading implementation enhances rotation efficiency and, as such, efficiency of the file system engine 202.

The rotation engine 204 includes volume analyzer 220, rotation worker thread 222, rotation worker thread 224, rotation worker thread 226, and queue 228. Although rotation engine 204 is illustrated with rotation worker threads 222-226, any number of rotation worker threads may be implemented and is not intended to limit embodiments described herein.

The volume analyzer 220 is generally configured to analyze the volumes and/or data stored in associated therewith. In this regard, the volume analyzer 220 analyzes, via an analysis thread, a volume(s), or portion thereof, and identifies a data set(s) to rotate from one volume tier to another volume tier. By way of example only, and with brief reference to FIG. 1, the volume analyzer 220 can analyze volume tier 108 to identify any cold data to rotate to the volume tier 110. Conversely, the volume analyzer 220 can analyze volume tier 110 to identify any hot data to rotate to the volume tier 108.

As can be appreciated, the volume analyzer 220 can analyze each tier of a volume to identify sets of data to rotate. For example, the volume analyzer 220 can analyze both a performance tier generally containing more-frequently accessed data and a capacity-efficiency tier generally containing less-frequently accessed data. In analyzing a volume, the volume analyzer 220 may analyze data and/or metadata associated with data set(s) to analyze whether the data set is in a correct volume tier or whether the data set should be rotated to another volume tier. For example, in some implementations, the volume analyzer 220 analyzes metadata associated with a data set to determine whether to rotate the data set to another tier.

Identifying a particular data set to rotate (also referred to herein as a candidate data set) can be performed in any number of ways. In some embodiments, a heat analysis is performed to determine a data set(s) to rotate. A heat analysis refers to analysis of whether to rotate data based on whether the data is hot or cold, irrespective of data size. For example, assume a data block is 50% utilized with 50% available for allocation. In cases that data within the data block is identified as cold (e.g., a least frequently accessed data set or a data set accessed below a threshold value), the heat analysis may result in rotation of the cold data from a performance tier to a capacity tier, even though not a full 64 MB of data to move. As such, the heat analysis may, in some cases, result in inefficient data rotation, particularly when the data set does not fulfill an entire block, region, or unit for data storage (e.g., 64 MB). In other embodiments, a greedy analysis is performed to determine a data set(s) to rotate. A greedy analysis refers to analysis of whether to rotate data based on size of data. For example, assume a capacity volume tier includes block sizes of 64 MB. In such a case, the greedy analysis may identify a data block(s) with the most maximum utilization (e.g., closest to using 64 MB) to move from one volume tier to another. In some cases, however, a most fulfilled block may contain the most frequently accessed data resulting in movement of hot data from a performance tier to a capacity tier. In yet other embodiments, a combination of a heat and greedy analysis may be applied to select data to rotate to optimize performance. For example, a combined analysis that analyzes both heat and data size may be applied to identify a data set to rotate.

In addition to identifying a data set, or candidate data set, to rotate, the volume analyzer 220 can also identify a destination location in another tier in which to move the data set. In this regard, for instance, assume a data set in a performance tier is identified as a candidate data set for rotation. In such a case, the volume analyzer 220 can identify a block, region, or unit of data storage within a capacity tier to which to rotate the candidate data set.

In some cases, to identify a destination location to which to rotate data may be performed using a forward-scanning process. In a forward-scanning process, the volume analyzer 220 can scan the set of blocks or units of storage in a particular volume tier (e.g., performance tier or capacity tier) in a forward manner to identify an available block (e.g., empty) to which a candidate data set can be rotated. In other cases, a backward-scanning process can be used to identify a destination location to which to rotate data. In a backward-scanning process, the volume analyzer 220 an scan the set of blocks or units of storage in a particular volume tier in a backward or reverse manner to identify an available block to which a candidate data set can be rotated. To this end, the block at the end of the volume tier can be analyzed first with progress toward the beginning of the volume tier. Advantageously, using a backward-scanning process can decrease the amount of time of scanning blocks to identify an available block for data allocation, as the forward-scanning process oftentimes results in scanning from beginning to near the end of the volume tier to identify an available destination location for data allocation. In some implementations, a recent (e.g. most recent) available block for data allocation may be recorded. In a subsequent identification for a destination location, the recorded recent available block can be used as a starting point for scanning or searching for the next available block for data allocation. Such an implementation can increase efficiency of scanning for available blocks or units of storage in a tier.

In accordance with identifying a data set in a first volume tier to rotate and a destination location to which to rotate the data in a second volume tier, the volume analyzer 220 may input (or add) a rotation entry into a queue, such as queue 228. A rotation entry generally refers to an entry that includes data used by a rotation worker thread to execute a data rotation. By way of example only, a rotation entry may include an indication of a data set, data block, file, region, or other source and corresponding volume tier for which a rotation is desired. A rotation entry may also include an indication of a block, region, unit of storage, or other indication of a destination location, and corresponding volume tier to which to rotate the data.

As can be appreciated, the volume analyzer 220 can continue to perform volume analysis and queue rotation entries while the rotation worker threads perform the data rotations identified via the queue rotation entries. Although generally described as the volume analyzer 220 performing volume analysis via a single thread, an analysis thread, as can be appreciated, any number of threads may be used to perform volume analysis.

The queue 228 obtains and adds rotation entries for access by rotation worker threads. In particular, queue 228 can obtain rotation entries via the volume analyzer 220. The rotation entries are generally added in the queue 228 such that the rotation worker threads can access the rotation entries and execute rotation.

In some cases, queue 228 may have a defined queue size to limit the amount of rotation entries queued for data rotation. A maximum queue size may be used to control or manage the amount of rotation entries queued for data rotation such that the rotation worker threads can keep up with the rotations indicated in the queue. In such cases, upon reaching the queue size limit, the volume analyzer 220 may discontinue volume analysis, or portions thereof, until the queue has availability for additional candidate data set entries. Additionally or alternatively, the queue 228 may discontinue accepting rotation entries until the queue size falls below the maximum threshold amount. Although illustrated with a single queue 228, as can be appreciated, any number of queues may be used to queue rotation entries.

Rotation worker threads, such as rotation worker threads 222, 224, and 226, are generally configured to execute data rotation. In particular, rotation worker threads perform or execute rotation of data from one volume tier to another volume tier. For example, a rotation worker thread may rotate a data set from a performance volume tier to a capacity volume tier. As another example, a rotation worker thread may rotate a data set from a capacity volume tier to a performance data tier. Although FIG. 2 illustrates three rotation worker threads, this is for illustration purposes only and not intended to limit embodiments described herein. Any number of worker threads may be used to perform data rotation. For instance, in some cases, ten rotation worker threads may be used to execute data rotations for a volume or set of volumes.

As described, performing data rotation can often be a more time consuming aspect of a rotation operation. In particular, performing data rotation can be more time consuming than performing volume analysis. As such, advantageously, and in accordance with embodiments described herein, the rotation worker threads can operate to execute data rotation on a thread separate and distinct from the thread used to analyze volumes. Using a thread(s) for executing data rotation independent from a thread for performing volume analysis enables operation of both threads in parallel, thereby improving efficiency of the entire rotation operation. Further, as performing data rotation can be time consuming, some implementations described herein include use of multiple rotation worker threads, executing independent of one another, to distribute the execution of data rotation. Distributed and independent execution of data rotation also increases efficiency of the rotation operation, as rotation executions can run in parallel.

In operation, a rotation worker thread can access a rotation entry in a queue 228. In this regard, when a rotation entry is in queue 228, a rotation worker thread can de-queue the rotation entry and execute a data rotation as indicated in the rotation entry. To execute a data rotation, the rotation worker thread may read the data set to rotate and write the data to the appropriate destination location (e.g., block or region) within the desired volume tier. In this way, the rotation worker thread may reference the rotation entry and utilize the indication of the data set and corresponding volume tier for which rotation is desired to read the data set to rotate. Thereafter, the rotation worker thread may write the data to the appropriate destination region in the corresponding volume tier, as indicated in the rotation entry. A rotation worker thread may repeat this process until the queue 228 is empty and then wait for another rotation entry to be added to the queue 228. As described, each rotation worker thread 222, 224, and 226 can operate in parallel to perform data rotations in accordance with rotation entries accessed via the queue 228.

### Example Implementations for Facilitating Enhancement of Data Rotation via Multithreading for Rotation Operations

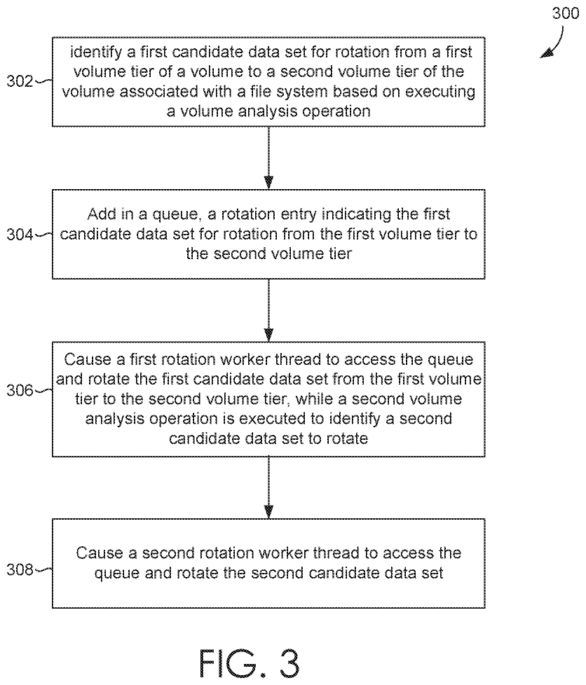

As described, various implementations can be used in accordance with embodiments of the present invention. FIGS. 3-5 provide methods of facilitating enhancement of data rotation via multithreading for rotation operations, in accordance with embodiments described herein. The methods 300, 400, and 500 can be performed, for example, via a file system engine, such as file system engine 102 of FIG. 1 and file system engine 202 of FIG. 2. The flow diagrams represented in FIGS. 3-5 are intended to be exemplary in nature and not limiting.

Turning initially to method 300 of FIG. 3, method 300 is directed to facilitating enhancement of data rotation via multithreading for rotation operations, in accordance with embodiments of the present invention. Initially, at block 302, a volume analysis operation is executed to identify a first candidate data set for rotation from a first volume tier of a volume to a second volume tier of the volume associated with a file system. In embodiments, the first volume tier and the second volume tier may be, respectively, a performance tier and a capacity tier (or vice versa). To identify a first candidate data set for rotation, the volume of the file system may be analyzed to detect or identify data that should be rotated from one volume tier to another volume tier, for example, based on extent to which data is or has been accessed. For example, hot data identified in a capacity tier may be identified to be rotated from the capacity tier to the performance tier. In contrast, cold data identified in a performance tier may be identified to be rotated from the performance tier to the capacity tier.

At block 304, a rotation entry indicating the first candidate data set for rotation from the first volume tier to the second volume tier is added in a queue. A rotation entry may additionally indicate a block or region of the second volume tier to which to rotate the first candidate data set. At block 306, a first rotation worker thread is caused to access the queue and rotate the first candidate data set from the first volume tier to the second volume tier. Such a first candidate data set rotation can occur while a second volume analysis operation is executed to identify a second candidate data set to rotate. As such, volume analysis and rotation execution can operate in parallel to increase the efficiency of the file system. Further, at block 308, a second rotation worker thread is caused to access the queue and rotate the second candidate data set. Concurrent or parallel execution of data rotation (e.g., via the first rotation worker thread and the second rotation worker thread) can increase the efficiency of the file system.

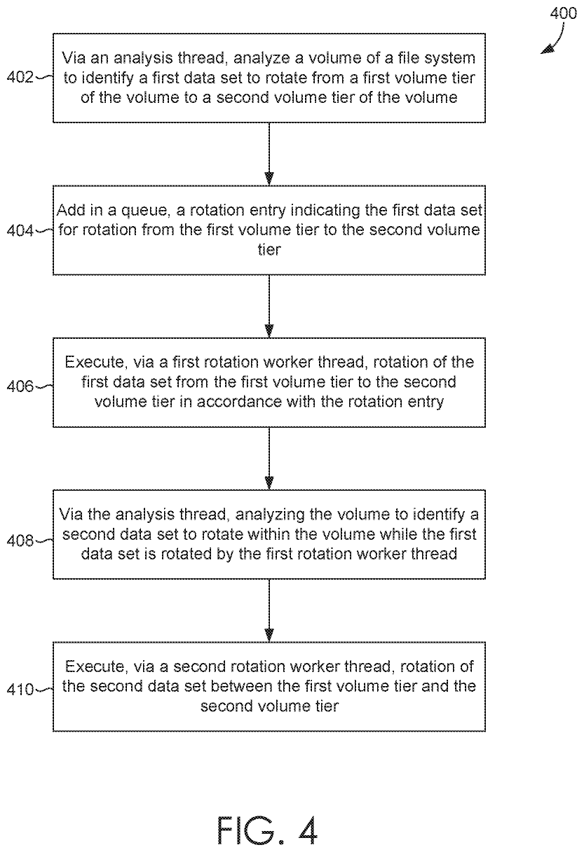

Turning now to FIG. 4, method 400 is directed to facilitating enhancement of data rotation via multithreading for rotation operations, in accordance with embodiments of the present invention. Initially, at block 402, via an analysis thread, a volume of a file system is analyzed to identify a first data set to rotate from a first volume tier of the volume to a second volume tier of the volume. In embodiments, the first volume tier and the second volume tier may be, respectively, a performance tier and a capacity tier (or vice versa). To identify a first data set for rotation, the volume of the file system may be analyzed to detect or identify data that should be rotated from one volume tier to another volume tier, for example, based on an extent to which data is or has been accessed. Further, via the analysis thread, a block or region to which to rotate the first data set can be identified. Such data can be used to generate a rotation entry for use in performing the corresponding data rotation.

At block 404, a rotation entry indicating the first data set for rotation from the first volume tier to the second volume tier is added in a queue. At block 406, a first rotation worker thread executes rotation of the first data set from the first volume tier to the second volume tier in accordance with the rotation entry. At block 408, the analysis thread analyzes the volume to identify a second data set to rotate within the volume while the first data set is rotated by the first rotation worker thread. Further, at block 410, a second rotation worker thread executes rotation of the second data set between the first volume tier and the second volume tier.

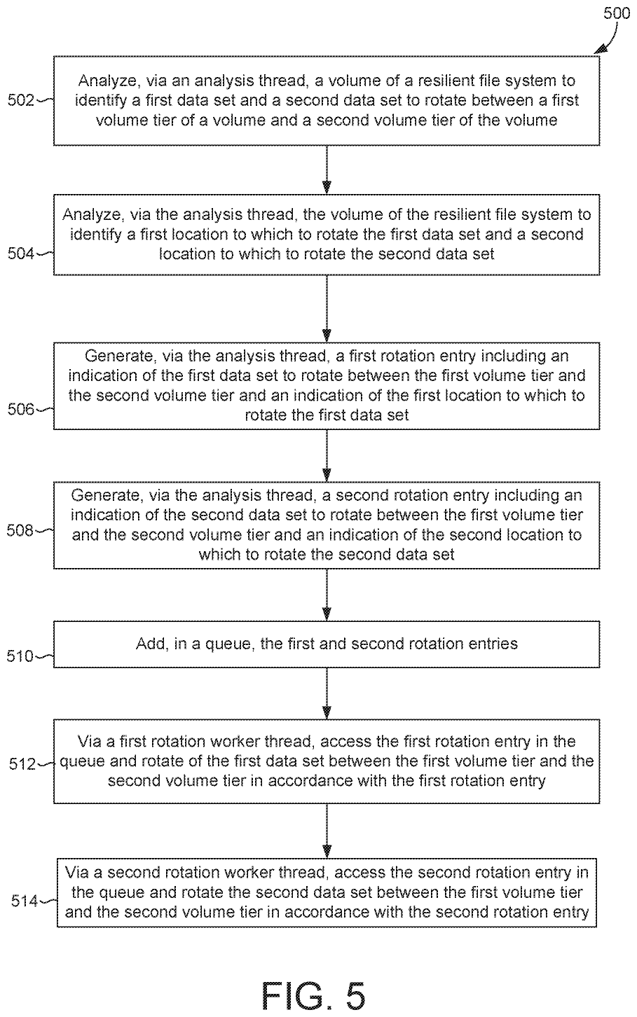

With reference now to FIG. 5, method 500 is directed to facilitating enhancement of data rotation via multithreading for rotation operations, in accordance with embodiments of the present invention. Initially, at block 502, a volume of a resilient file system is analyzed, via an analysis thread, to identify a first data set and a second data set to rotate between a first volume tier of a volume and a second volume tier of the volume. At block 504, the volume of the resilient file system is analyzed, via the analysis thread, to identify a first location to which to rotate the first data set and a second location to which to rotate the second data set. At block 506, the analysis thread generates a first rotation entry including an indication of the first data set to rotate between the first volume tier and the second volume tier and an indication of the first location to which to rotate the first data set. At block 508, the analysis thread generates a second rotation entry including an indication of the second data set to rotate between the first volume tier and the second volume tier and an indication of the second location to which to rotate the second data set.

At block 510, the rotation entries are queued in a queue. As can be appreciated, the rotation entries can be generated and queued at different times. At block 512, a first rotation worker thread accesses the first rotation entry in the queue and rotates the first data set between the first volume tier and the second volume tier in accordance with the first rotation entry. At block 514, a second rotation worker thread accesses the second rotation entry in the queue and rotates the second data set between the first volume tier and the second volume tier in accordance with the second rotation entry. In embodiments, the first rotation worker thread and the second rotation worker thread operate, at least in part, in parallel.

### Example File System Environment

With reference to the file system environment 600 that includes a file system (e.g., Resilient File System—ReFS), embodiments described herein support the functionality of the technical solution described above. The file system environment 600 includes distributed components of the file system that are communicatively implemented in combination with other integrated components that implement aspects of the technical solution. The file system environment 600 refers to the hardware architecture and software framework that support the functionality of the technical solution.

At a high level, the file system provides configuration rules (e.g., logic and data structures) used to manage storage and retrieval, and naming and grouping of data. In particular, the configuration rules are based on a copy-on-write (i.e., write-to-new) design. In this regard, the file system is a copy-on-write file system. In particular, an application programming interface operates with a storage engine to provide a write-to-new B+ key-value file system. The file system can support data integrity, file-level snapshots (“block cloning”), data tiering and dynamic layout on disks, among other functionality.

FIG. 6 shows a high level architecture file system environment 600 having components in accordance with implementations of the present disclosure. It should be understood the arrangement described herein is set forth only as examples and other arrangements, instead of those shown, are contemplated. Among other components not shown, the file system environment 600 includes file system engine 600A having storage engine 610, disk 650, application programming interface 670, and in-memory 690. The storage engine 610 includes allocators 620, object table 622, and schema 624, B+ table objects 630 (with private allocators 632), and disk 650 includes files 652, and metadata 660 (with critical (metadata) 662, non-critical (metadata) 664); API 670 includes input/output manager interface 672; and in-memory 690 having file system in-memory data structures 692.

The storage engine 610 provides allocators (e.g., global allocators and private allocator) that allocate storage of table objects. In particular, the storage engine 610 provides B+ table objects 630 with internal private allocators 632, and an object table 622 to track the B+ table objects. The storage engine 610 supports storing roots of one B+ table within another B+ table and supports stream extents. Storing roots of B+ tables within another can leave the embedded table unable to have an entry in the object table. Directories are B+ table objects referenced by the object table 622. Files are B+ tables whose roots are embedded in the row of directories. Streams are implemented as a table of file extents whose roots are embedded in the file record.

In operation, the file system creates and manipulates B+ table objects in order to store file system metadata (e.g., critical and non-critical metadata) and uses the stream extent functionality for user stream data. In particular, the file system implements two types of metadata (i.e., global “critical” metadata 662 and non-critical metadata 664). Critical metadata 662 is managed independently of non-critical metadata 664. For example, writing critical metadata 662 is based on a different logic from the non-critical metadata 664 based on the separation from the critical metadata. Writing metadata may be implemented based on a locking mechanism.

The storage engine 610 supports a schema 624 for organizing information (e.g., B+tables of files and directories) in the file system. For example, when a B+ table is created, the table object is assigned an ID in the object table. Every entry is a <key, value> pair in the form <object_id, root_location> where object_id is the volume-unique identifier of the object and root location is the block address of the root bucket of the table. Because all directories are durable table objects in file system, the vast majority of entries in the object table refer to directories.

Directories are B+ table objects that are responsible for a single, flat namespace. Directories logically contain files, links to files in other directories, and links to other directories. It is through directories and links to directories that the traditional hierarchical file system namespace is built. Rows in a directory table are logically of the form <key, <type, value>> where key is unique in the table, type indicates the way in which value should be interpreted, and value is then type-specific. Directories, being tables, are composed of rows.

Files 652 are stored in association with directories. For example, files 652 may have file records that are B+ tables rooted in a directory B+ table. Files in directories can appear as <key, value> pairs of the form <file name, file record>. In one implementation, file_name can be a Unicode string and file_record is an embedded B+ table. Embedded B+ tables in storage engine may embed only their roots in the value of another table. In this regard, a file record is constructively the root of a table.

In-memory data structures of the file system support in-memory operations and other associated operations of the file system. At a high level, in-memory processing can be based on file objects, file control blocks (FCB) and stream control blocks (SCB). In particular, a file object points to the SCB data structure which represents a single data entity contained in a single file. The file that contains the data entity is represented by a file control block. Durable changes for the SCB and the FCB are supported using a B+ table. Every open file in file system can be implemented with a single FCB as its in-memory anchor. An open file with a single data stream also has an SCB representing that stream. The FCB, being responsible for the on-disk file record, points to the open storage engine B+ table object that represents the file. In this regard, files are B+ tables, while file attributes are rows in the B+ table.

The file system API 670 is an application programming interface through which services of the file system can be requested. For example, the input/output manger interface 672 can support read operations, write operations, metadata management operations, and maintenance operations (e.g., creating or initializing a file system, verifying the file system for integrity, and defragmentation). An operating system of a device using the file system can provide the API to support the file system operations. It is contemplated by various features of the technical solution of the present invention can be performed using file system environment 600 and other variations and combinations thereof.

### Example Distributed Computing Environment

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Operating Environment

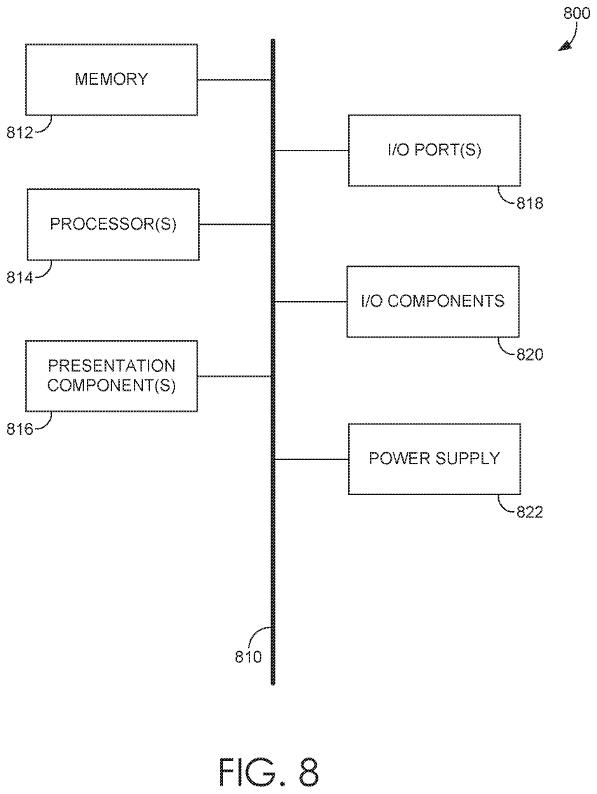

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

With reference to the technical solution environment described herein, embodiments described herein support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the system components can manage resources and provide services for system functionality. Any other variations and combinations thereof are contemplated with embodiments of the present invention.

By way of example, the technical solution system can include an API library that includes specifications for routines, data structures, object classes, and variables may support the interaction between the hardware architecture of the device and the software framework of the technical solution system. These APIs include configuration specifications for the technical solution system such that the different components therein can communicate with each other in the technical solution system, as described herein.

Having identified various components utilized herein, it should be understood that any number of components and arrangements may be employed to achieve the desired mfunctionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code.

Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A file system engine for providing multi-threaded rotation operations in file systems, the system comprising:
one or more hardware processors; and
one or more computer storage media storing computer-useable instructions that, when used by the one or more processors, cause the one or more processors to execute:
identifying a first candidate data set for rotation from a first volume tier of a volume to a second volume tier of the volume associated with a file system based on a volume analysis operation;
adding a rotation entry in a queue, the rotation entry indicating the first candidate data set for rotation from the first volume tier to the second volume tier;
while identifying a second candidate data set for rotation from the first volume tier to the second volume tier, causing a first rotation worker thread to access the queue and rotate the first candidate data set from the first volume tier to the second volume tier;
adding a second rotation entry in the queue, the second rotation entry indicating the second candidate data set for rotation from the first volume tier to the second volume tier; and
causing a second rotation worker thread to access the queue and rotate the second candidate data set from the first volume tier to the second volume tier.

2. The computing system of claim 1, wherein the volume analysis operation is performed via an analysis thread separate from the first rotation worker thread and the second rotation worker thread.

3. The computing system of claim 2, wherein the analysis thread executes in parallel with the second rotation worker thread.

4. The computing system of claim 1, wherein the rotation entry further indicates a destination location to which to rotate the first candidate data set.

5. The computing system of claim 1, wherein the first rotation worker thread rotates the first candidate data set from the first volume tier to the second volume tier in accordance with the rotation entry.

6. The computing system of claim 1, wherein the first volume tier comprises a performance tier that performs fast data storage and the second volume tier comprises a capacity tier that provides capacity-efficient storage.

7. The computing system of claim 1, wherein the first volume tier comprises a capacity tier that provides capacity-efficient storage and the second volume tier comprises a performance tier that performs fast data storage.

8. The computing system of claim 1, wherein the first candidate data set for rotation is identified based on an amount of accesses to the first candidate data set.

9. A computer-implemented method for providing multi-threaded rotation operations in file systems, the method comprising:
identifying a first data set to rotate from a first volume tier of the volume to a second volume tier of the volume based on analyzing, via an analysis thread, a volume of a file system;
adding a rotation entry to a queue, the rotation entry indicating the first data set for rotation from the first volume tier to the second volume tier; and
based on the rotation entry, rotating the first data set from the first volume tier to the second volume tier using a first rotation worker thread, rotating the first data set being executed by the first rotation worker thread in parallel with the analysis thread analyzing the volume to identify a second data set to rotate within the volume.

10. The method of claim 9 further comprising executing, via a second rotation worker thread, rotation of the second data set between the first volume tier and the second volume tier.

11. The method of claim 10, wherein executing rotation of the second data set is based on a new rotation entry in the queue indicating the second data set for rotation, the new rotation entry generated based on the analysis thread analyzing the volume to identify the second data set to rotate with the volume.

12. The method of claim 9, wherein the file system comprises a resilient file system.

13. The method of claim 9 further comprising identifying, via the analysis thread, a destination location of the second volume tier to which to rotate the first data set, wherein identifying the destination location comprises scanning regions of the second volume tier in a backward-scanning process.

14. The method of claim 9, wherein analyzing, via the analysis thread, the volume to identify the first data set to rotate from the first volume tier of the volume to the second volume tier of the volume comprises using a heat analysis, a greedy analysis, or a combination thereof.

15. The method of claim 9, wherein the first volume tier comprises one of a performance tier that performs fast data storage or a capacity tier that provides capacity-efficient storage, and the second volume tier comprises the other of the performance tier or the capacity tier.

16. One or more computer storage media having computer-executable instructions embodied thereon that, when executed by one or more processors, cause the one or more processors to perform a method for providing multi-threaded rotation operations in file systems, the method comprising:
identifying a first data set and a second data set to rotate between a first volume tier of the volume and a second volume tier of the volume based on analyzing, via an analysis thread, a volume of a resilient file system;
adding to a first rotation entry and a second rotation entry to a queue, the first rotation entry indicating the first data set for rotation and the second rotation entry indicating the second data set for rotation;
based on the first rotation entry, rotating the first data set between the first volume tier and the second volume tier using a first rotation worker thread; and
based on the second rotation entry, rotating the second data set between the first volume tier and the second volume tier, wherein the first rotation worker thread and the second rotation worker thread operate in parallel.

17. The media of claim 16, wherein the analysis thread operates in parallel with the first rotation worker thread or the second rotation worker thread.

18. The media of claim 16, wherein the first volume tier comprises one of a performance tier that performs fast data storage or a capacity tier that provides capacity-efficient storage, and the second volume tier comprises the other of the performance tier or the capacity tier.

19. The media of claim 16, wherein the first rotation worker thread de-queues the first rotation entry, reads the first data set from the first volume tier, and writes the first data set to the second volume tier.

20. The media of claim 16, wherein the first data set for rotation is identified based on an amount of accesses to the first data set.
